(19) United States
(12) Patent Application Publication
(10) Pub. No.: US 2002/0171052 A1
(43) Pub. Date: Nov. 21, 2002

(54) Compact surface quality meter

(76) Inventor: Gregory R. Wiles, Royal Oak, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/151,380

(22) Filed: May 20, 2002

Related U.S. Application Data
(60) Provisional application No. 60/292,746, filed on May 21, 2001.

(51) Int. Cl. G01V 8/00; G01N 21/86

(52) U.S. Cl. 250/559.11

(57) ABSTRACT

An apparatus for measuring the visual characteristics of the surface of a workpiece includes a light source which produces a beam of light. One or more mirrors are positioned so as to direct the light from the source onto the workpiece for reflection therefrom, and to direct the reflected beam onto a photodetector. At least one of the mirrors is supported on a movable mirror carriage which is coupled to a member which contacts the workpiece surface and adjusts the position of the mirror or mirrors supported by the carriage so as to assure that the reflected beam falls on the photodetector. The detector may be mechanically scanned across the reflected beam to provide a spatial profile of that beam.

### RELATED APPLICATION

This patent application claims priority of U.S. Provisional Patent Application Serial No. 60/292,746 filed May 21, 2001, also entitled “Compact Surface Quality Meter.”

### FIELD OF THE INVENTION

This invention relates generally to instrumentation for measuring the surface quality of the finish of workpieces. More specifically, the invention relates to a low cost, compact, simple to use device which is capable of measuring the surface quality of curved and other non-planar workpiece surfaces.

### BACKGROUND OF THE INVENTION

The surface appearance of many articles of manufacture such as motor vehicles, appliances, and furniture is very important. Surface finishing of such items generally involves polishing, painting, plating and the like; and, it is desirable to be able to quantify the quality of finish of such surfaces for evaluation and quality control. As a consequence, the industry has developed a number of parameters such as gloss, distinctness of image, orange peel, and the like which can be utilized to characterize and quantify surface quality. Such parameters are generally measured by reflecting a beam of light from the surface of the workpiece being measured, and correlating the characteristics of the light reflected from the surface with the particular parameter. There are a number of methods and algorithms well known to those of skill in the art for accomplishing such measurements. Typically, surface quality measurements are carried out in a production environment; and as a consequence, self-contained metering devices are employed to direct a beam of light onto a workpiece, detect the reflected light, and generate an electrical signal which corresponds to one or more attributes of the reflected light. In some instances, such systems further process the signal within the measuring device to provide a direct readout of surface quality parameters. In other instances, the signal is then conveyed to another unit for processing.

Heretofore, such measuring apparatus has generally been utilized in connection with the high volume production of motor vehicles, appliances and the like, and prior art surface quality monitoring systems are generally very large and expensive. Also, prior art apparatus has generally been configured for measurements of relatively planar surfaces such as motor vehicle panels and the like; and hence, is not capable of accurately measuring the surface quality of items having a relatively small radius of curvature.

There is a need for a surface quality measuring apparatus which is compact, low in cost, easy to use and which can accommodate relatively small, fairly high curved, workpieces. As will be explained hereinbelow, the present invention provides a small, simple, low cost surface quality measuring system which includes a uniquely configured optical system which reduces the system's size and cost, and which enables it to accommodate highly curved surfaces. In addition, the present invention also includes a low cost detector assembly which provides performance equivalent to that achieved through the use of expensive detector arrays.

### BRIEF DESCRIPTION OF THE INVENTION

Disclosed herein is an apparatus for measuring the visual characteristics of the surface of a workpiece. The apparatus includes a housing having a light source supported therein and operable to provide a beam of light. The apparatus further includes a photodetector supported by the housing. The photodetector is operable to provide an electrical signal in response to the illumination thereof. A first mirror is supported by the housing so as to direct the beam of light from the light source onto the surface of a workpiece for reflection therefrom so as to produce a reflected beam. A second mirror is supported by the housing so as to receive the reflected beam and direct it onto the photodetector. At least one of the first and second mirrors is supported by a mirror carriage so as to be movable relative to the housing, along an axis which is generally normal to the surface of the workpiece at a point on the workpiece at which the beam of light impinges. A workpiece contact member is in mechanical communication with a mirror carriage. The workpiece contact member projects from the housing and is operable, when the housing is in contact with the workpiece, to engage the workpiece proximate to the location thereupon at which the beam of light impinges onto it, and to move the mirror carriage to a position along the aforementioned axis so that the reflected beam of light falls on the detector.

In further embodiments of the invention, a second and a third mirror may be supported by the housing and disposed so as to direct the beam of light from the light source to the workpiece and to the detector. One or more of these third and fourth mirrors may be mounted on the mirror carriage.

In further embodiments of the invention, the photodetector has an active area which is less than the cross-sectional area of the reflected beam of light, and the apparatus includes a scanner for scanning the active area of the photodetector across at least a portion of the cross-sectional area of the reflected beam so that the electrical signal produced by the detector is a time varying signal corresponding to the intensity profile of the scanned cross-sectional area of the reflected beam. Scanning of the detector may be accomplished by mechanical means such as a pushbutton, or electrical means such as a solenoid or other actuator. The scanning system may include a position indicator associated therewith for providing an output signal indicative of the positional relationship of the active area of the photodetector relative to the cross-sectional area of the reflected beam. This position indicator may comprise an electronic linear position sensor.

### DESCRIPTION OF THE DRAWINGS

FIG. 1 is a schematic, cutaway, depiction of one embodiment of the present invention;

FIG. 2 is a schematic depiction of another embodiment of the present invention;

FIG. 3 is a schematic depiction of a detector assembly of the present invention;

FIG. 4 is a graph of the spatial distribution of the intensity of a reflected beam of light as being scanned by the detector of the assembly of FIG. 3;

FIG. 5 is a drawing of a contact pad which may be utilized in the present invention;

FIG. 6a is a drawing of a portion of the mirror carriage of the present invention showing the action of the contact member thereof; and

FIG. 6b is a perspective view of a portion of the contact member of FIG. 6a.

### DETAILED DESCRIPTION OF THE INVENTION

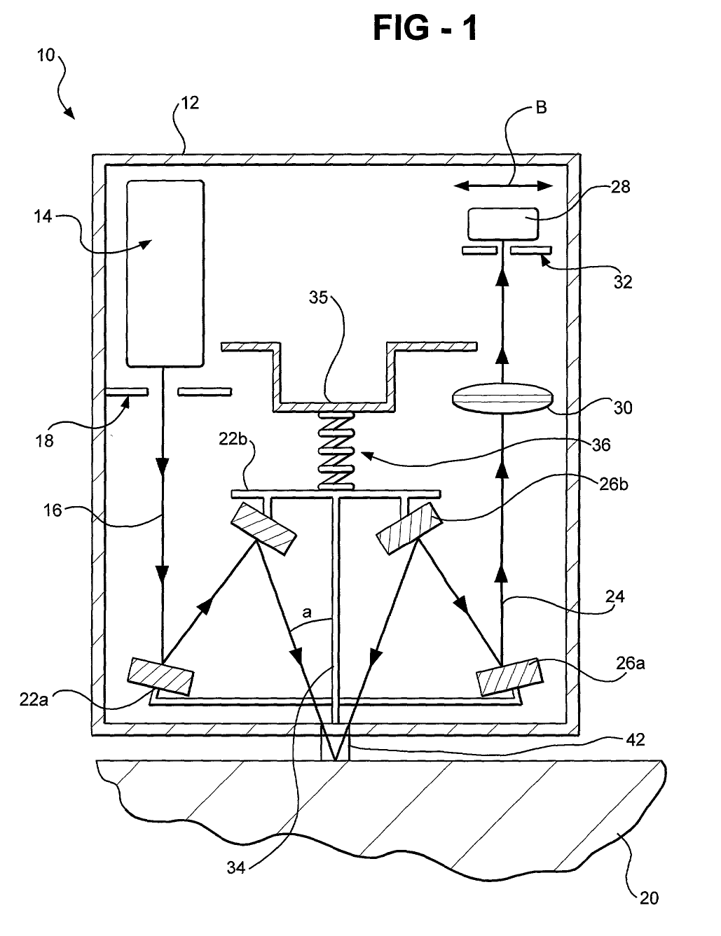

The present invention is directed to an apparatus for measuring the visual characteristics of the surface of a workpiece. The system of the present invention is compact, low in cost, and employs a unique optical system and detector assembly. Referring now to FIG. 1, there is shown one embodiment of apparatus 10 structured in accord with the principles of the present invention. The apparatus 10 of FIG. 1 is enclosed within a housing 12 which contains and supports various elements of the apparatus. The housing 12 may be fabricated from metal, polymers, and the like. While the housing 12 is shown in FIG. 1 as enclosing the elements of the apparatus 10, it is to be understood that the housing may be otherwise configured, and within the context of this disclosure it should not be interpreted as being restricted to structures which enclose the remaining components of the system. But rather, the term “housing” is meant to include support structures, both open and closed, which support and retain the elements described and claimed herein. As such, the housing may comprise a supporting framework, an optical bench or the like. Disposed within the housing 12 is a light source 14 which in the preferred embodiment comprises a solid state laser, most preferably operating at near infrared wavelengths. Other light sources such as a discharge lamp, an incandescent lamp and the like may be readily substituted herein by one of skill in the art.

In the illustrated embodiment, the light source 14 emits a beam of light 16, and as illustrated, the apparatus may include a field stop or other aperture for shaping or collimating, or otherwise controlling the size or character of the beam 16. Likewise, filters or polarizers may be included in the optical path. In the illustrated embodiment, the beam of light 16 is directed onto a workpiece 20 by a first pair of mirrors 22a, 22b. In the illustrated embodiment, the incident beam 16 strikes the workpiece 20 at an angle “a” which is 20° from normal. This is an industry standard for measuring gloss, and is referred to as a 20° gloss measurement.

The workpiece 20 reflects the incident beam of light 16 so as to produce a reflected beam 24 which is directed by a second pair of mirrors 26a, 26b onto a photodetector 28. As illustrated, the reflected beam 24 passes through a lens and slit 32 prior to striking the detector 28; although, it is to be understood that these elements may be eliminated; alternatively, other elements may be substituted therefor.

The photodetector receives the reflected beam 24 and generates an electrical signal proportional thereto. The detector 28 may comprise any photoresponsive device known in the art. For example, the detector 28 may be a linear array detector which provides a position responsive signal indicating the spatial distribution of the reflected beam 24. However, and as will be explained in detail hereinbelow, the detector 28 may preferably comprise a simple, low cost photodiode which is scanned across the reflected beam 24, as indicated by double arrow “B” so as to provide information about the spatial distribution of the reflected beam.

The output of the photodetector 28 may be processed using methods and algorithms known in the art to provide measurements such as gloss, distinctness of image and the like, indicative of the quality of the surface of the workpiece 20. Such processing may be accomplished within the apparatus 10 by a microprocessor (not shown), or processing may be carried out at another location.

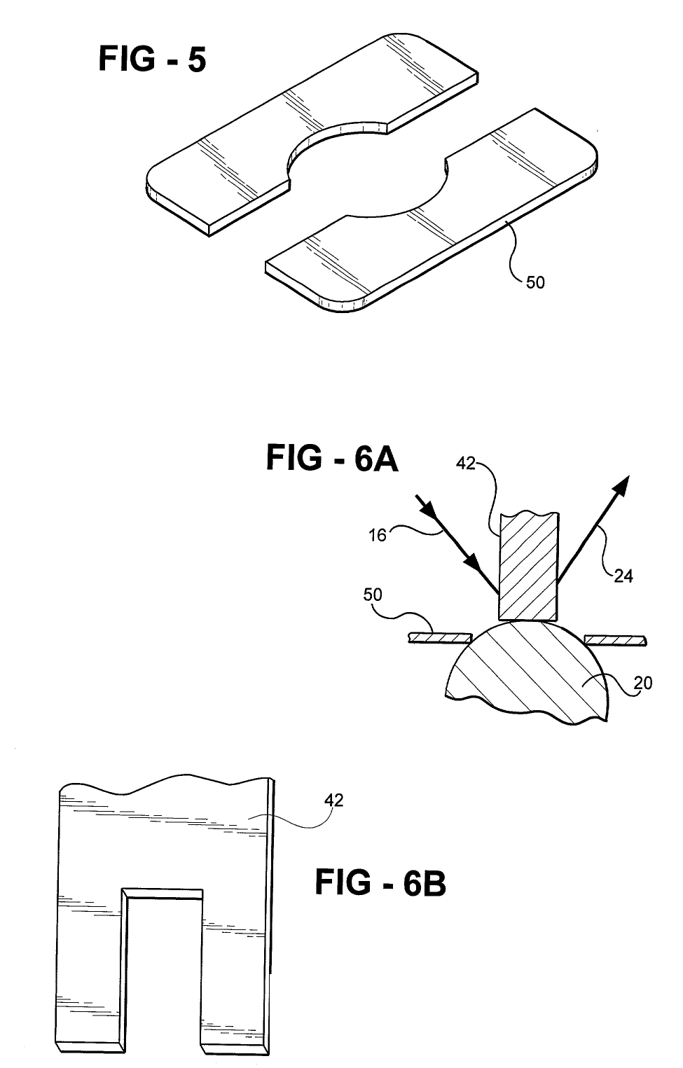

In accord with the present invention, the mirrors 22a, 22b, 26a, 26b are mounted onto a mirror carriage 34 which is supported in the housing 12 so as to be movable along an axis which is generally normal to the surface of the workpiece 20 at the point thereupon at which the beam of light 16 impinges. As illustrated, the mirror carriage 34 is supported in the housing 12 by a support bracket 35, and is biased by means of a spring 36, and operates in cooperation with a contact member 42 (best shown in FIGS. 6a and 6b) which engages the surface of the workpiece 20 and moves the carriage along the axis so as to reposition the mirrors so that the reflected beam 24 will fall onto the detector 28. As illustrated, all four of the mirrors are mounted on the carriage in a fixed relationship relative to one another, and are translated in a group, along the axis. In other embodiments of the invention, only a portion of the mirrors are mounted on the carriage.

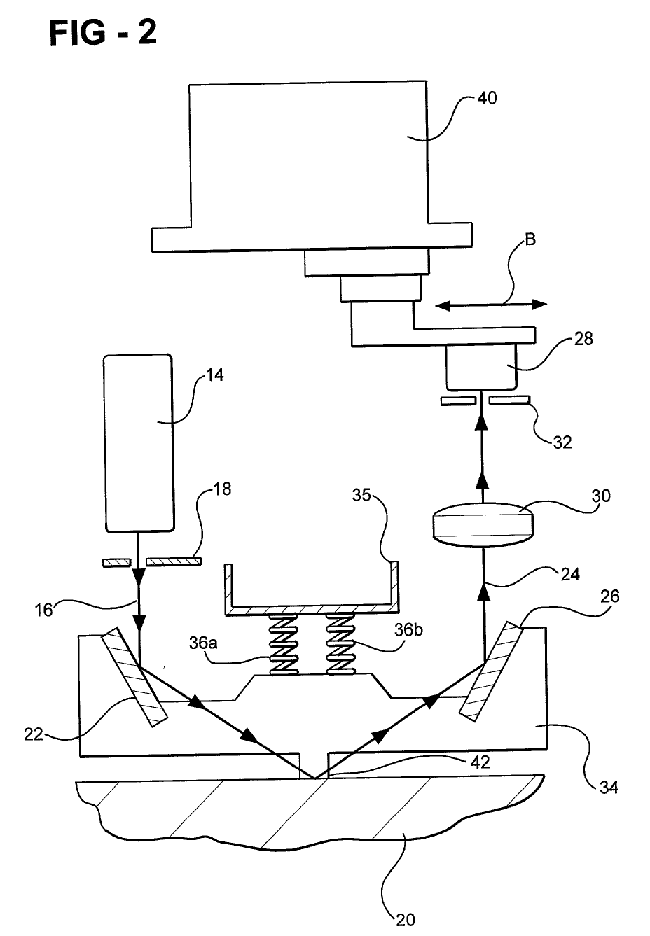

Referring now to FIG. 2, there is shown another embodiment of the present invention, generally similar to the FIG. 1 embodiment, but configured to measure 60° gloss. In the FIG. 2 embodiment, the housing is not shown, and it is to be understood that the various elements are all appropriately supported.

The apparatus of FIG. 2 includes a light source 14 and field stop 18 generally similar to those discussed hereinabove. The light source 14 produces an incident beam 16 which is directed onto the workpiece 20 by a mirror 22. (It will be noted that in this embodiment, only a single mirror 22 directs the incident beam 16 onto the workpiece 20.) The incident light 16 is reflected from the workpiece to produce a reflected beam 24 which is directed onto a photodetector 28 by means of a mirror 26. As in the previous embodiment, a lens 30 and detector slit 32 are employed to direct and shape the reflected beam 24. In this embodiment, an electrically powered servo 40 operates to scan the photodetector 28, which is most preferably a photo diode, across the reflected beam 24 in the direction “B” as indicated.

As in the FIG. 1 embodiment, the mirrors 22, 26 of the FIG. 2 embodiment are mounted onto a mirror carriage 34 (which in this illustration is not in cross section) in a fixed relationship to one another. The carriage is supported by the housing by a bracket 35, so as to be movable along an axis generally normal to the surface of the workpiece 20. The FIG. 2 embodiment better depicts the contact member 42 which engages the workpiece 20 and also moves the carriage 34 along its axis of motion. In the FIG. 2 embodiment, the carriage includes two springs 36a, 36b for biasing the motion of the carriage.

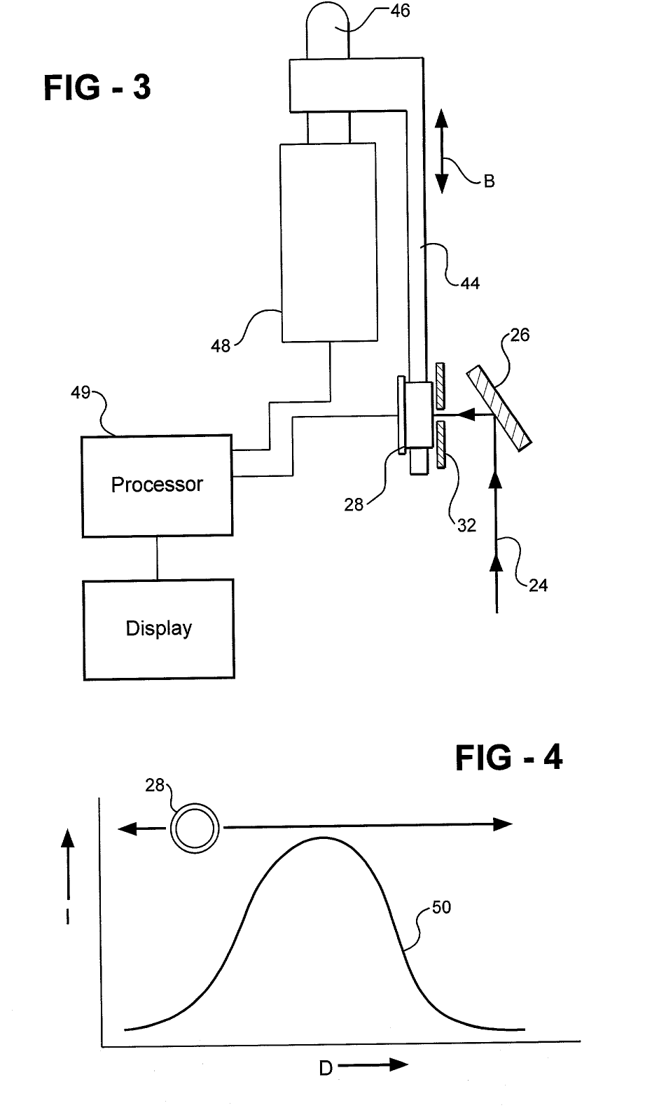

Referring now to FIG. 3, there is shown another version of detector assembly for scanning a photodetector across the reflected beam of light. As depicted in FIG. 3, a photodetector 28 is mounted onto a carriage 44 which includes a pushbutton 46 or other such mechanical actuator which moves the carriage 44 and detector 28 along a back and forth path of travel as indicated by arrow B. Associated with the carriage 44 is a linear position sensor 48. Such devices are known in the art, and operate to provide an electrical signal indicative of linear displacement. In the assembly of FIG. 3, a reflected beam of light 24 is directed onto the photodetector 28, in this instance by a mirror 26. The photodetector 28 has an active area which is less than the cross-sectional area of the beam 24, and as the detector is scanned across the beam 24, it produces a varying output signal. The linear position sensor 48 produces a corresponding signal which is indicative of the detector's position and which may be correlated with the signal from the photodetector so as to provide a composite signal indicative of the spatial profile of the reflected light. As shown, the outputs of the photodetector 28 and position sensor 48 may be directed to a signal processor 49 which generates an output signal in response thereto and activates an appropriate display 51.

Referring now to FIG. 4, there is shown a graph 50 depicting the intensity (I) of a reflected beam of light as a function of the cross-sectional dimension (D) of the beam. As shown herein, this distribution is approximately gaussian; although, depending upon the nature of the surface quality of the workpiece, other distributions may be encountered. FIG. 4 also depicts, in schematic form, a photodetector 28 which has an active area smaller than the cross-sectional dimension of the reflected beam. As shown in the figure, the detector 28 is scanned across the width of the cross section of the beam, and this will cause the detector 28 to produce a positionally varying signal which embodies information describing the spatial distribution of the intensity of the reflected beam. As is known in the art, this information can be processed to provide measurements of parameters such as distinctness of image, gloss, orange peel and the like. It is a notable feature of the present invention that by the use of a relatively low cost small active area photo diode in connection with a scanning system, the need to employ expensive positionally sensitive detectors, such as linear arrays, is avoided.

Referring now to FIG. 5, there is shown a depiction of a contact pad which may be employed in the practice of the present invention. The contact pad 50 is a portion of, or is affixed to, the housing and provides an aperture through which the incident and reflected beams pass. In addition, the contact pad establishes contact with the workpiece. It has been found that a contact pad having a circular center cutout portion superimposed over a narrower cutout slot is particularly advantageous insofar as it functions to align spherical, cylindrical, or otherwise curved workpieces 20 with the optical center of the apparatus.

Referring now to FIG. 6a and FIG. 6b, there is shown an enlarged view of a portion of an apparatus generally similar to that of FIG. 1 or FIG. 2. FIG. 6a shows a workpiece 20 in engagement with a contact pad 50. As further shown in FIG. 6a, the workpiece 20 is highly curved; consequently, the portion of the workpiece being measured actually projects a small distance into the housing of the apparatus. As shown, the contact member 42 of the mirror carriage engages the workpiece surface and correctly positions the mirrors (not shown) so that the incident beam 16 strikes the optical center of the workpiece 20 so that the reflected beam 24 is correctly aligned with the detector system. FIG. 6b shows a perspective view of the contact member 42. As will be noted, a cutout center portion permits the incident 16 and reflected beam 24 to pass therethrough. The contact member may be otherwise configured provided it does not interfere with the incident and reflected beams.

It is to be understood that in view of the teaching presented herein, other modifications and variations of the present invention may be readily implemented by one of skill in the art. The foregoing drawings, discussion and description are illustrative of specific embodiments of the invention, but are not meant to be limitations upon the practice thereof. It is the following claims, including all equivalents, which define the scope of the invention.

1. An apparatus for measuring the visual characteristics of the surface of a workpiece, said apparatus comprising:
a housing;
a light source supported by said housing, said light source being operable to provide a beam of light;
a photodetector supported by said housing, said photodetector being operable to provide an electrical signal in response to illumination thereof;
a first mirror supported by said housing so as to direct said beam of light from said light source so as to impinge onto a surface of a workpiece for reflection therefrom so as to produce a reflected beam;
a second mirror supported by said housing so as to receive said reflected beam and direct said reflected beam onto said photodetector;
a mirror carriage having at least one of said first and second mirrors supported thereupon, said mirror carriage being supported by said housing so as to be movable relative thereto along an axis which is generally normal to the surface of said workpiece at a point at which said beam of light impinges thereonto; and
a workpiece contact member in mechanical communication with said mirror carriage, said workpiece contact member projecting from said housing and being operable, when said housing is in contact with said workpiece, to engage said workpiece proximate to the location thereupon where said beam of light impinges onto said workpiece, and to move said mirror carriage to a position along said axis so that said reflected beam of light falls on said detector; whereby said apparatus is operable to measure the visual characteristics of a workpiece having a curved surface.

2. The apparatus of claim 1 wherein said photodetector has an active area which is less than the cross-sectional area of the reflected beam of light, said apparatus further including a scanner for scanning the active area of the photodetector across at least a portion of the cross-sectional area of the reflected beam so that the electrical signal produced by said detector is a time varying signal corresponding to the intensity profile of the scanned cross-sectional area of the reflected beam.

3. The apparatus of claim 1, wherein said first mirror and said second mirror are mounted on said mirror carriage.

4. The apparatus of claim 1, further including a third mirror which functions, in cooperation with said first mirror, to direct said beam of light onto said workpiece.

5. The apparatus of claim 4, wherein said third mirror is mounted on said mirror carriage.

6. The apparatus of claim 1, further including a fourth mirror operable in combination with said second mirror to direct said reflected beam onto said photodetector.

7. The apparatus of claim 6, wherein said fourth mirror is mounted on said mirror carriage.

8. The apparatus of claim 2, wherein said scanner includes an electrically actuated solenoid which moves the photodetector.

9. The apparatus of claim 2, wherein said scanner includes a manually activated member which moves said photodetector.

10. The apparatus of claim 2, wherein said scanner has a position indicator associated therewith, said position indicator being operable to provide an output signal indicative of the positional relationship of the active area of the photodetector relative to the cross-sectional area of the reflected beam.

11. The apparatus of claim 10, wherein said position indicator comprises an electronic linear position sensor.

12. The apparatus of claim 1, wherein said detector comprises a photodiode.

13. The apparatus of claim 1, wherein said photodetector comprises an array of photoresponsive devices.

14. The apparatus of claim 1, wherein said light source comprises a laser.

15. The apparatus of claim 14, wherein said laser comprises an infrared emitting laser.

16. The apparatus of claim 1, wherein said beam of light impinges said workpiece at an angle of 20°.

17. The apparatus of claim 1, wherein said beam of light impinges said workpiece at an angle of 60°.

18. In an apparatus for measuring the visual characteristics of the surface of a workpiece, said apparatus comprising a light source disposed and operative to project a beam of light onto a surface of a workpiece for reflection therefrom so as to provide a reflected beam, and a photodetector which is operative to receive said reflected beam and provide an output signal corresponding thereto, wherein the improvement comprises in combination:
said photodetector having an active area which is less than the cross-sectional area of the reflected beam of light; and
said apparatus further including a scanner for scanning the active area of the photodetector across at least a portion of the cross-sectional area of the reflected beam over a period of time so that the output signal produced by said detector is a time varying signal corresponding to the intensity profile of the scanned, cross-sectional area of the reflected beam.

19. The apparatus of claim 18, wherein said scanner is operative to move the photodetector relative to the reflected beam.

20. An apparatus for measuring the visual characteristics of the surface of a workpiece, said apparatus comprising:
a light source which is operable to provide a beam of light and to direct said beam of light onto a surface of a workpiece for reflection therefrom so as to provide a reflected beam;
a photodetector which is operative to receive said reflected beam and to provide an output signal corresponding thereto;
at least one mirror which is disposed so as to receive and redirect at least a portion of said reflected beam;
a mirror carriage having at least one of said at least one mirror supported thereupon, said mirror carriage being supported by a support member so as to be movable along an axis which is generally normal to said workpiece at a point thereupon at which said beam of light is reflected therefrom;
a workpiece contact member in mechanical communication with said mirror carriage, said workpiece contact member being operable to engage said workpiece proximate to the point thereupon at which said beam of light is reflected therefrom, and to move said mirror carriage along said axis in response to the position of said workpiece so that said at least one mirror redirects said reflected beam so that it falls on said photodetector.
